(19) United States
(12) Patent Application Publication
(10) Pub. No.: US 2024/0109162 A1
(43) Pub. Date: Apr. 4, 2024

(54) SANDER

(71) Applicant: MAKITA CORPORATION, Anjo-shi (JP)

(72) Inventor: Tsuyoshi KURODA, Anjo-shi (JP)

(73) Assignee: MAKITA CORPORATION, Anjo-shi (JP)

(21) Appl. No.: 18/368,207

(22) Filed: Sep. 14, 2023

(30) Foreign Application Priority Data
Oct. 4, 2022 (JP) 2022-160545

(51) Int. Cl. B24B 23/02; B24B 47/12; B24B 55/05; B24B 55/10; H02K 9/06

(52) U.S. Cl. CPC B24B 23/02; B24B 47/12; B24B 55/052; B24B 55/102; H02K 9/06

(57) ABSTRACT

A sander has a motor, an output shaft, a pad, a dust collecting fan arranged on the upper side relative to the pad, a motor cooling fan that is arranged on the upper side relative to the dust collecting fan, a housing and a cover. The housing has at least one air hole formed through the housing in a direction crossing an axis of the output shaft. The cover is arranged apart from the air hole outside the housing and covers the air hole.

### CROSS-REFERENCE TO RELATED APPLICATIONS

The present application claims priority to Japanese patent application No. 2022-160545 filed on Oct. 4, 2022. The contents of the foregoing application are hereby fully incorporated herein by reference.

### TECHNICAL FIELD

The present disclosure relates to a sander.

### BACKGROUND

Sanders with a dust collecting fan or a cooling fan are known. For example, Japanese Unexamined Patent Application Publication No. 2013-129016 discloses a sander having a motor for driving a pad, an output shaft that is formed separately from a rotary shaft of the motor and to which the pad is mounted, and a fan that is provided on the output shaft. A user can perform sanding operation by pressing against a workpiece sanding paper mounted on the pad.

### SUMMARY

The working environment may be deteriorated if dust generated by sanding operation scatters out from the sander. It is therefore desired to provide a technique for favorably maintaining the working environment.

According to an aspect of the present disclosure, a sander is provided. The sander has a motor, an output shaft, a pad (pad member, pad part, sanding part), a dust collecting fan, a motor cooling fan, a housing and a cover. The output shaft has an axis extending in an up-down direction and is configured to be rotated by the motor. The pad is operably connected to the output shaft and configured to be driven by the motor. The dust collecting fan is fixed to the output shaft so as to surround the output shaft in a circumferential direction. Where, in the up-down direction, a side on which the pad is arranged relative to the dust collecting fan is defined as a lower side of the sander and a side opposite to the lower side is defined as an upper side of the sander, the motor cooling fan is arranged on the upper side relative to the dust collecting fan and configured to be rotated by the motor. The housing is arranged on the upper side of the pad. The housing is configured to house the motor, the motor cooling fan, the dust collecting fan and at least part of the output shaft. The housing further has at least one air hole formed through the housing in a direction crossing the axis. The cover is arranged outside the housing. The cover is configured to cover the air hole while being apart from the air hole.

According to this aspect, even if dust is mixed in the motor cooling air (exhaust air from the motor cooling fan) discharged from the air hole, the possibility that dust scatters to the working environment is reduced. Therefore, the working environment can be favorably maintained.

### BRIEF DESCRIPTION OF THE DRAWINGS

FIG. 1 is an external perspective view of a sander.

FIG. 2 is a side view of the sander.

FIG. 3 is a top view of the sander.

FIG. 4 is a bottom view of the sander.

FIG. 5 is an external, perspective view of the sander, with a cover removed therefrom.

FIG. 6 is a side view of the sander, with the cover removed therefrom.

FIG. 7 is a top view of the sander, with the cover removed therefrom.

FIG. 8 is a sectional view taken along line VIII-VIII in FIG. 3.

FIG. 9 is a sectional view taken along line IX-IX in FIG. 3.

FIG. 10 is a partial, sectional view of FIG. 9, for illustrating air flow flowing through a passage defined by a fan housing part, the pad and the cover.

FIG. 11 is a sectional view taken along line XI-XI in FIG. 3.

FIG. 12 is a sectional view taken along line XII-XII in FIG. 2.

FIG. 13 shows an image formed by projecting a tongue part and its periphery on a plane P1.

FIG. 14 shows an image formed by projecting a tongue part and its periphery on a plane P1 in a comparative example.

### DETAILED DESCRIPTION OF THE EMBODIMENT

In one non-limiting embodiment according to the present disclosure, the cover may have a first part and a second part. The first part may be formed to be connected to (abut) the housing above (on the upper side relative to) the air hole. The second part may be configured to be apart from the housing and to extend in the up-down direction on the lower side of the first part.

According to this embodiment, dust discharged from the air hole is led downward from the air hole, so that the possibility that dust scatters toward a user is reduced.

In addition or in the alternative to the preceding embodiment, the pad may have at least one dust suction hole formed through the pad in the up-down direction. The housing may have a lower wall facing an upper surface of the pad. The lower wall may have a lower opening for communication between the inside of the housing and the dust suction hole. A lower end of the second part may be located between the lower wall of the housing and the upper surface of the pad in the up-down direction. The sander may further include a first passage and a second passage. The first passage may be defined by the second part and an outer surface of the housing. The second passage may be defined by the lower wall of the housing and the upper surface of the pad. The first passage may communicate with the dust suction hole via the second passage.

According to this embodiment, the first passage communicates with the dust suction hole and the lower opening of the housing via the second passage. Therefore, dust discharged from the air hole is drawn to air flow that is generated by the dust collecting fan and flows from the dust suction hole toward the lower opening of the housing, so that the possibility that dust mixed in the motor cooling air scatters toward a user is further reduced. Further, the flow rate (volume) of air for dust collection is increased by the confluence (joining) of the motor cooling air discharged from the air hole and the air flow generated by the dust collecting fan. Thus, the dust collecting efficiency is improved.

In addition or in the alternative to the preceding embodiments, the lower end of the second part may be apart from the upper surface of the pad in the up-down direction.

According to this embodiment, even if the flow rate of air flowing from the dust suction hole toward the lower opening of the housing is reduced, the motor cooling air discharged from the air hole is discharged to the outside of the cover through the clearance (spaced part) between the lower end of the cover (the second part) and the upper surface of the pad. Thus, the motor cooling efficiency is maintained.

In addition or in the alternative to the preceding embodiments, the air hole may be arranged substantially at the same position as the motor cooling fan in the up-down direction and on a radially outer side of the motor cooling fan in the housing.

According to this embodiment, the motor cooling air is relatively quickly discharged from the housing. Thus, the motor cooling efficiency is improved.

In addition or in the alternative to the preceding embodiments, the at least one air hole may be a plurality of air holes. The cover may be shaped along a contour of the housing.

According to this embodiment, the passage of the motor cooling air can be formed with a substantially constant width, and the size increase of the sander can be suppressed. Further, the motor cooling air is discharged from the plural air holes, so that the motor cooling efficiency is improved.

In addition or in the alternative to the preceding embodiments, the sander may further include a dust discharge part. The dust discharge part may be configured to be connected to the housing and extend in a direction crossing the up-down direction. The housing except a connection part with the dust discharge part may be formed in a circular arc shape around the axis of the output shaft in a cross section orthogonal to the up-down direction. The air holes may be arranged in a circular arc in the housing. The cover may have a dome-like shape covering the housing.

According to this embodiment, the passage of the motor cooling air can be formed with a substantially constant width, and the size increase of the sander can be suppressed. Further, the motor cooling air is discharged from the plural air holes, so that the motor cooling efficiency is improved.

In addition or in the alternative to the preceding embodiments, the dust collecting fan and the motor cooling fan may be integrally formed with each other.

According to this embodiment, the sander can be reduced in size compared with a structure in which the dust collecting fan and the motor cooling fan are formed separately from each other.

In addition or in the alternative to the preceding embodiments, the cover may be formed as a separate member from the housing.

According to this embodiment, complication of the structure of the housing is suppressed.

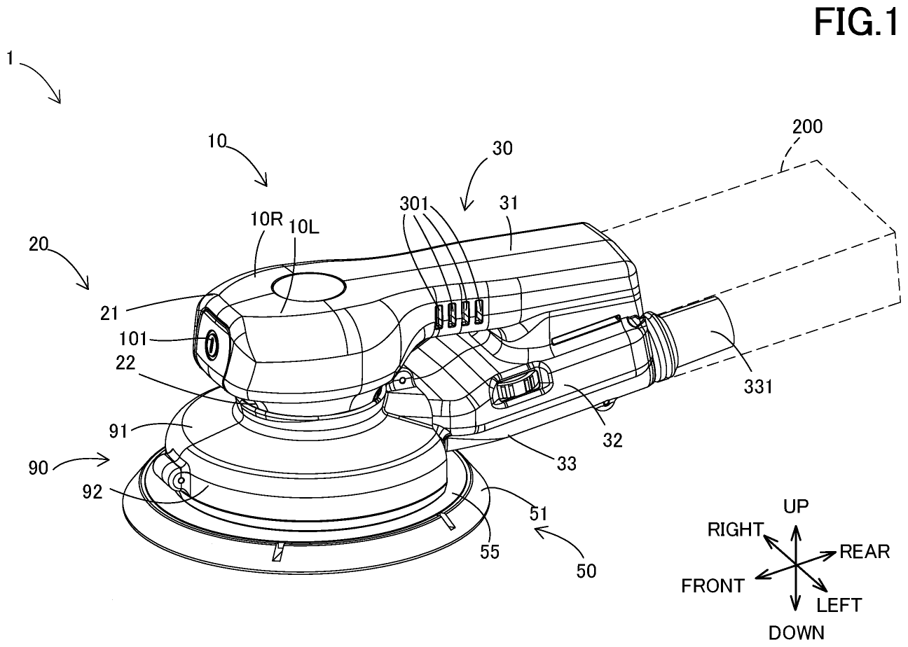

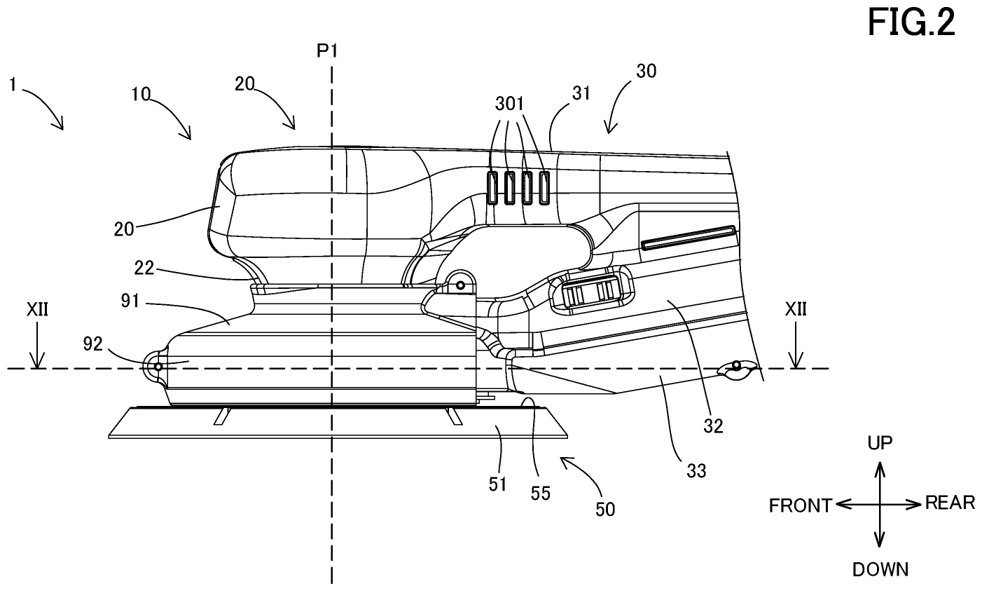

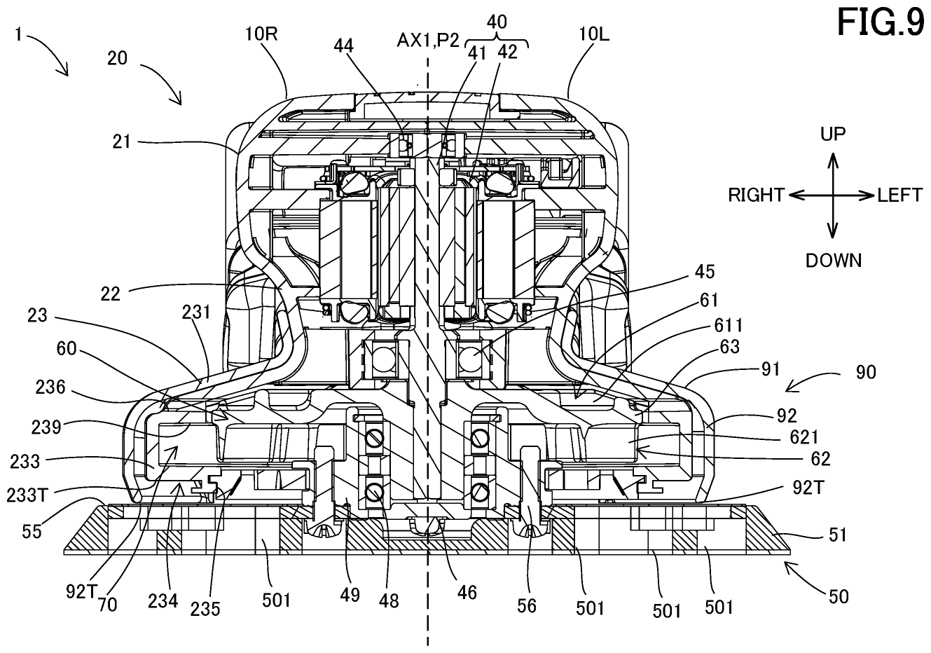

A sander 1 is now described as a representative embodiment of the present disclosure with reference to FIGS. 1 to 14. The sander 1 is also referred to as a random orbit sander.

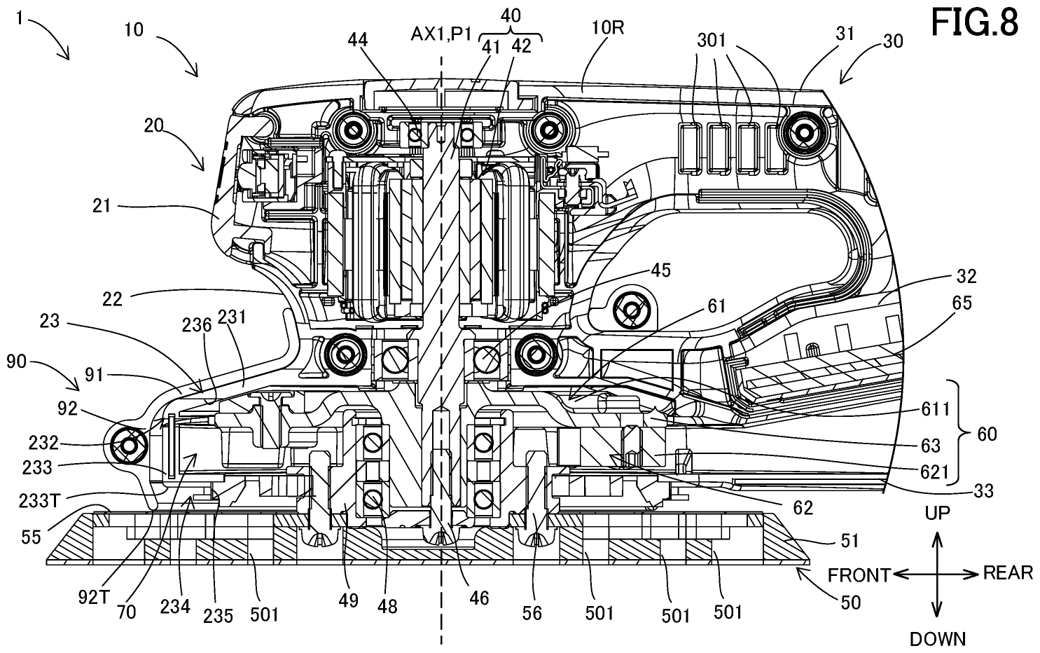

As shown in FIG. 8, the sander 1 has a motor 40, a centrifugal fan (hereinafter referred to as a fan 60), a housing 10 and a pad 50 (pad member, pad part, sanding part). The pad 50 is arranged on one end side in an extending direction of a rotational axis AX1 of the motor 40 (a motor shaft 41) and configured to perform eccentric motion and rotational motion (random orbital motion) by rotation of the motor 40. As shown in FIG. 1, the housing 10 includes a front housing part 20 that houses the motor 40 and the fan 60, and a rear housing part 30. The rear housing part is connected to the front housing part 20 and extends in a direction away from the front housing part 20 in a longitudinal direction of the sander 1.

In the following description, for convenience sake, the extending direction of the rotational axis AX1 is defined as an up-down direction of the sander 1. The up-down direction is also an axial direction of the motor shaft 41. In the up-down direction, the side of the front housing part 20 on which the pad 50 is arranged is defined as a lower side, and the opposite side is defined as an upper side. In a direction orthogonal to the up-down direction, the longitudinal direction of the sander 1 is defined as a front-rear direction of the sander 1. The longitudinal direction of the sander 1 is also an extending direction of the rear housing part 30. In the front-rear direction, the side of the rear housing part 30 on which a connection part with the front housing part 20 is located is defined as a front side, and the opposite side is defined as a rear side. Further, a direction orthogonal to the front-rear direction and the up-down direction is defined as a left-right direction of the sander 1.

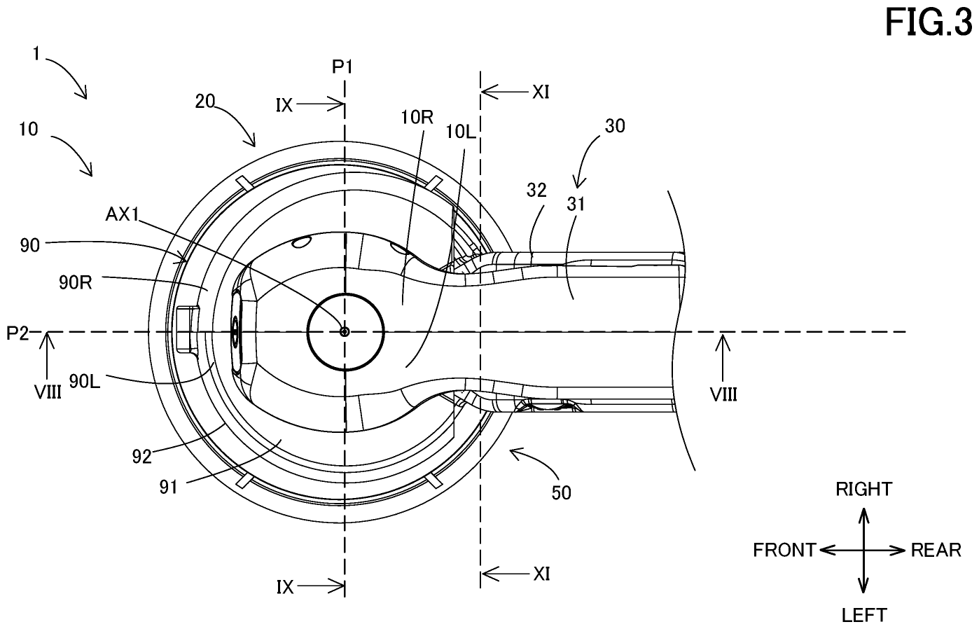

In FIGS. 3, 4 and 7, imaginary planes P1 and P2 are shown. The imaginary plane P1 includes the rotational axis AX1 and extends in parallel to the left-right direction. The plane P2 includes the rotational axis AX1 and extends orthogonally to the plane P1. The housing 10 of this embodiment is formed by two halves (a left part 10L and a right part 10R) fixedly connected together in the left-right direction. The housing 10 can be divided into the left part 10L and the right part 10R along the plane P2.

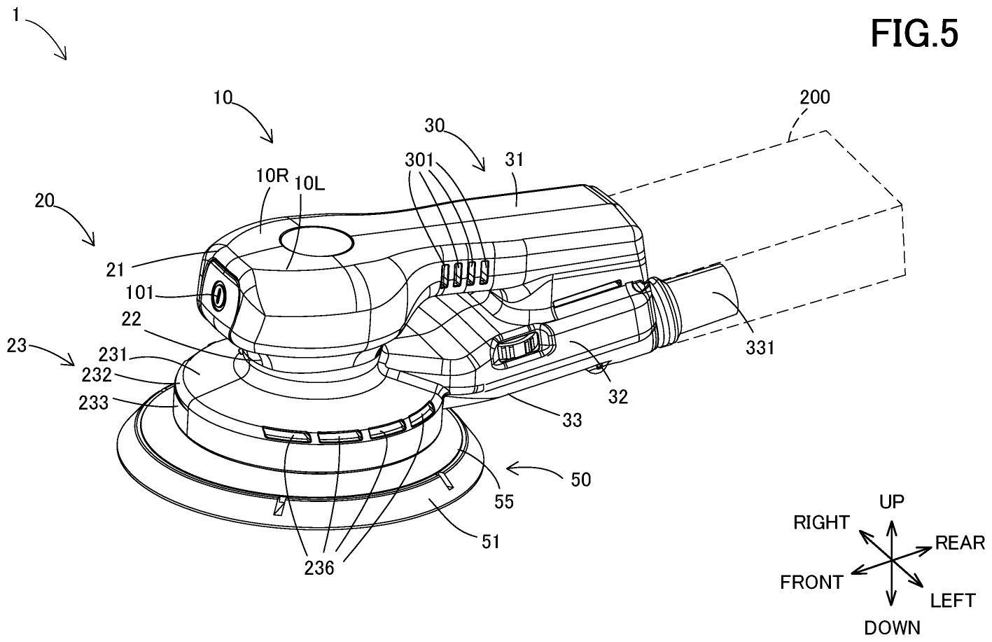

As shown in FIGS. 1 to 3 and 5 to 8, the front housing part 20 is arranged on the pad 50 and defines an outer shell of a front part of the sander 1. The front housing part 20 is formed to be closed above the motor shaft 41 and to surround the motor 40 and the fan 60. As shown in FIG. 5, the front housing part 20 includes an upper part 21, a lower part 23 and an intermediate part 22 formed between the upper part 21 and the lower part 23. The intermediate part 22 has a smaller outer diameter than the upper part 21 and the lower part 23. The front housing part 20 as a whole is formed in a multistage shape each stage having a different outer diameter. The upper part 21 mainly houses the motor 40, and the lower part 23 mainly houses the fan 60. In a part (specifically, a lower wall 234) of the lower part 23 that faces the pad 50, a lower opening 235 is formed with the rotational axis AX1 as its center (see FIG. 8). The upper part 21 and the lower part 23 are hereinafter referred to as a motor housing part 21 and a fan housing part 23, respectively.

The motor housing part 21 has a size and a shape suitable to be held by a user's hand. The motor housing part 21 serves as a main holding part of the sander 1. A switch 101 for manually starting and stopping the motor 40 is provided on a front end of the motor housing part 21.

The fan housing part 23 has a generally dome-like shape. An outer edge of the fan housing part 23 is located radially inward of an outer edge of the pad 50. In this embodiment, the fan housing part 23 is shaped along the contour of the fan 60. As shown in FIG. 8, the fan housing part 23 has an upper wall 231, a side wall 233 and a lower wall 234. The upper wall 231 has a roof-like shape extending radially outward from a connection with the intermediate part 22. The side wall 233 is connected to the upper wall 231 and extends in the up-down direction. The lower wall 234 protrudes radially inward from a lower end 233T of the side wall 233. The lower wall 234 has the above-mentioned opening 235. The inside of the fan housing part 23 communicates through the opening 235 with dust suction holes 501 (described below in detail) formed in the pad 50.

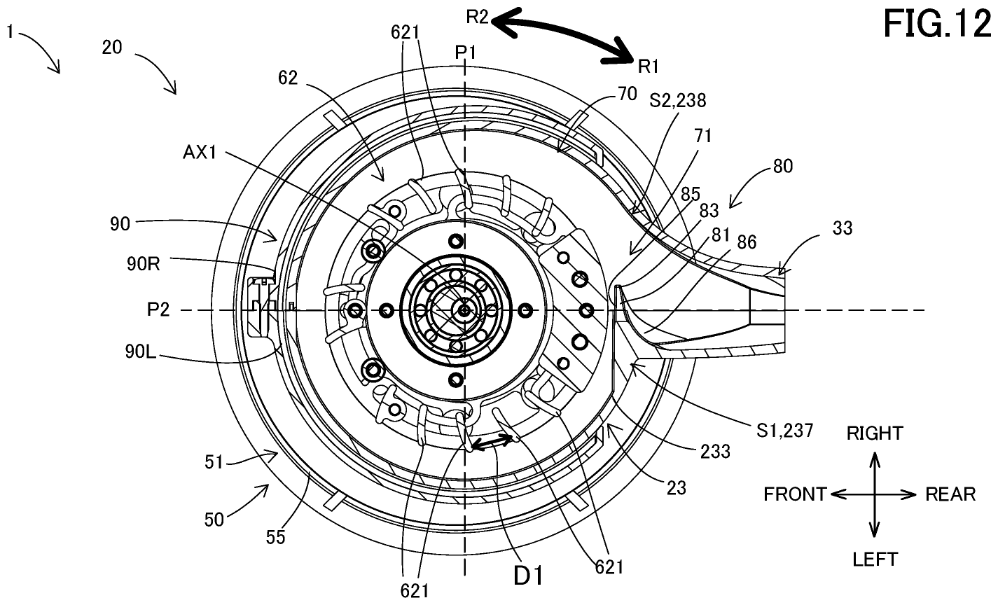

A dust discharge part 33 for discharging dust is connected to a rear part of the side wall 233. The fan housing part 23 except a connection part with the dust discharge part 33 is formed in a circular arc shape around the rotational axis AX1 in a cross section (see FIG. 12) orthogonal to the up-down direction.

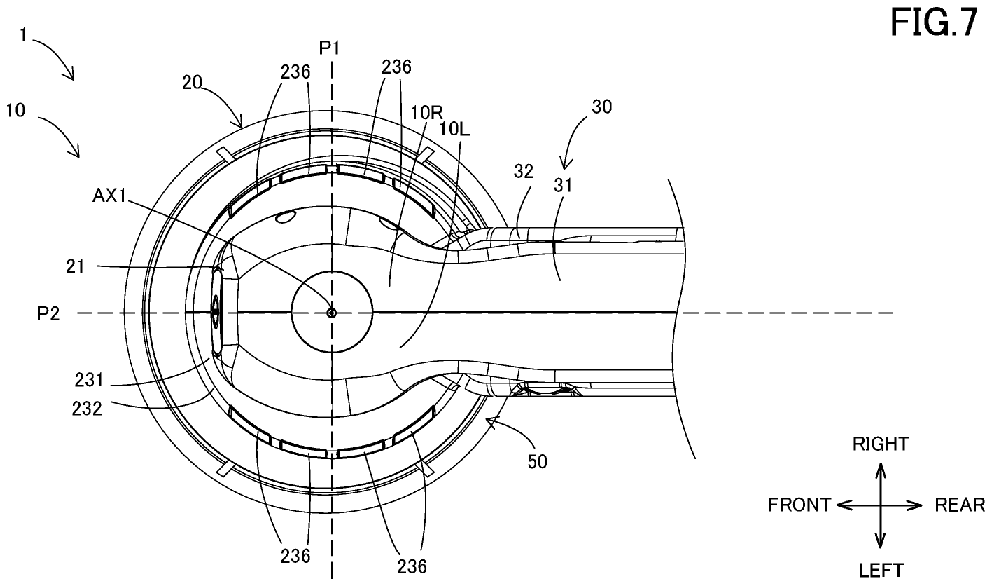

As shown in FIGS. 5 to 7, the fan housing part 23 further has air holes 236. The air holes 236 are formed through the fan housing part 23 in a direction (the radial direction, the left-right direction) crossing the up-down direction, in a connection part 232 between the upper wall 231 and the side wall 233. In this embodiment, four such air holes 236 are formed in each of (positions corresponding to) the connection part 232 of the left part 10L and the connection part 232 of the right part 10R. As shown in FIG. 7, the air holes 236 are arranged in a circular arc in top view. The air holes 236 are formed in a position corresponding to a radially outer side of the motor cooling fan 61 in the fan housing part 23, which will be described below in detail.

As shown in FIGS. 1, 2, 5 and 7, the rear housing part 30 has a bifurcated shape having parts separated from each other in the up-down direction, and the bifurcated parts are connected to the front housing part 20 in the front-rear direction. The inside of the front housing part 20 communicates with the inside of the rear housing part 30. In this embodiment, the rear housing part 30 includes a grip part 31, the dust discharge part 33 and a controller housing part 32.

The grip part 31 is connected to a rear part of the motor housing part 21 and extends in the front-rear direction. An upper end surface of the grip part 31 is continuous and flush with an upper end surface of the motor housing part 21. The grip part 31 serves as an auxiliary holding part. When performing sanding operation, a user can hold the motor housing part 21 with one hand and hold the grip part 31 (specifically, a front half part of the grip part 31) with the other hand. A rear end part of the grip part 31 is configured such that a power cord for supplying an external AC power source can be connected thereto.

Air inlets 301 are formed in the front half part of the grip part 31. In this embodiment, four air inlets 301 are formed in (a position corresponding to) the front half part of the grip part 31 in each of the left and right parts 10L, 10R. When the fan 60 rotates, air (outside air) outside of the housing 10 flows into the front housing part 20 from the air inlets 301, which will be described below in detail.

The dust discharge part 33 is connected to a rear end of the fan housing part 23 and extends in the front-rear direction. The dust discharge part 33 has a generally flat tubular shape. The inside of the dust discharge part 33 communicates with the inside of the fan housing part 23. As shown in FIGS. 1 and 5, a mounting part 331 is formed in a rear end part of the dust discharge part 33 and configured such that a dust collecting pack 200 for collecting (storing) dust can be removably attached thereto. Dust in the fan housing part 23 is guided toward the dust collecting pack 200 through the dust discharge part 33. In place of the dust collecting pack 200, a hose of a dust collector may be connected to the dust discharge part 33.

The controller housing part 32 is provided on top of the dust discharge part 33 and formed to be slightly larger than the grip part 31 and the dust discharge part 33 in the left-right direction. As shown in FIG. 8, the controller housing part 32 houses a controller 65 for controlling driving of the motor 40. The controller housing part 32 is divided from the dust discharge part 33 by a tubular wall of the dust discharge part 33.

The structures of elements disposed within the housing 10 are now described with reference to FIGS. 8, 9 and 12. As described above, the front housing part 20 houses the motor 40 and the fan 60.

The motor 40 is housed in the motor housing part 21. The motor 40 has a motor body 42 having a stator and a rotor, and a motor shaft 41. The motor shaft 41 is supported by bearings 44, held by the front housing part 20.

The fan 60 is arranged on the lower side of the motor 40 and housed in the fan housing part 23. The fan 60 is fixed to the motor shaft 41 so as to surround the motor shaft 41 in a circumferential direction. In this embodiment, the fan 60 is fixed orthogonally to a lower end part of the motor shaft 41 with a bolt 46 extending in the up-down direction. An upper side of the fan 60 faces the motor body 42 in the up-down direction, and a lower side of the fan 60 faces the pad 50 in the up-down direction. A bearing 48 is mounted onto the fan 60 eccentrically to the rotational axis AX1 of the motor shaft 41, and a bearing box 49 is further mounted eccentrically onto the fan 60 via the bearing 48.

The fan 60 includes a disc-like main plate 63, blades 611 protruding upward from an upper surface of the main plate 63, and blades 621 protruding downward from a lower surface of the main plate 63. As shown in FIG. 12, the blades 621 radially extend in a curved shape from the center of the main plate 63 to an outer periphery thereof, and are arranged at prescribed intervals in the circumferential direction. Similarly, although not shown, the blades 611 also radially extend in a curved shape from the center of the main plate 63 to an outer periphery thereof, and are arranged at prescribed intervals in the circumferential direction. An upper part of the fan 60 faces the motor 40 and functions as a motor cooling fan, and a lower part of the fan 60 faces the pad 50 and functions as a dust collecting fan. The upper part of the fan 60 and the lower part of the fan 60 are hereinafter also referred to as a motor cooling fan 61 and a dust collecting fan 62, respectively. In this embodiment, the motor cooling fan 61 and the dust collecting fan 62 are integrally formed, so that the sander 1 can be reduced in size compared with a structure having these fans formed separately from each other.

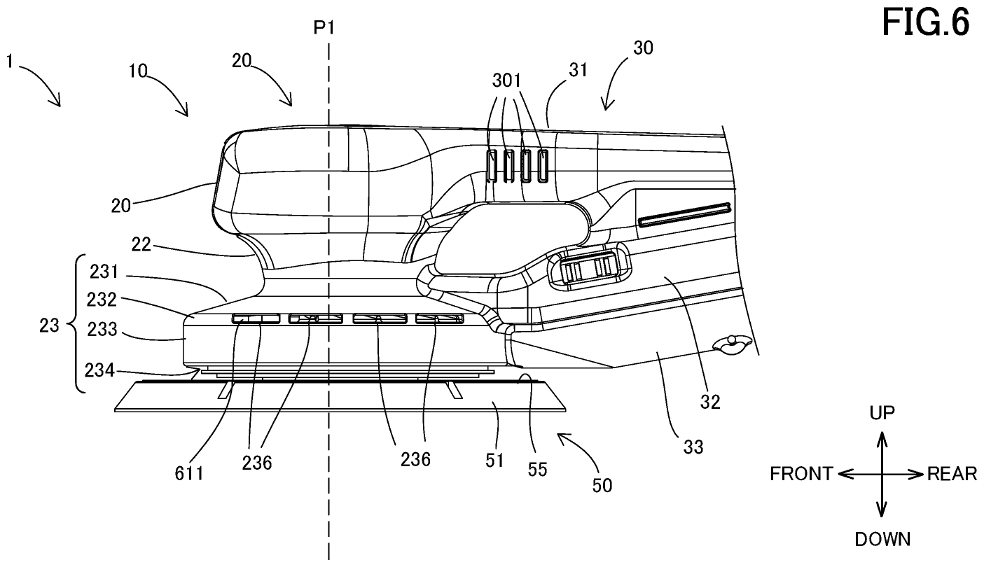

As shown in FIG. 8, the motor cooling fan 61 (the blades 611) is arranged substantially at the same position as the air holes 236 of the fan housing part 23 in the up-down direction. As shown in FIG. 6, a user can visually recognize the blades 611 through the air holes 236 from a direction orthogonal to the up-down direction (such as the left-right direction). Air (exhaust air, motor cooling air) generated by the motor cooling fan 61 is discharged from the air holes 236, which will be described below in detail.

In this embodiment, a balance weight for reducing vibration caused by orbital motion is fixed to each of upper and lower surfaces of the main plate 63. Therefore, as shown in FIG. 12, the intervals (distances, pitches) between the blades 621 in the circumferential direction are not the same. Similarly, the intervals (distances, pitches) between the blades 611 in the circumferential direction are not the same. The “intervals” (between the blades 621) here refer to the distances between radially outer ends of the adjacent blades 621. The shortest interval between the blades 621 is hereinafter also referred to as a distance D1.

As shown in FIG. 8, the pad 50 is arranged at the lowermost part of the sander 1. The pad 50 includes a sanding pad 51. The sanding pad 51 has a disc-like shape and is configured such that sanding paper can be mounted thereon. The sanding pad 51 is joined to the bearing box 49 with bolts 56 extending in the up-down direction. A bottom face of the sanding pad 51 functions as a sanding face for sanding a workpiece during use of the sander 1. In this embodiment, a driving axis of the pad 50 is also the rotational axis AX1 of the motor 40. Thus, the motor shaft 41 functions as an output shaft. In the sander 1, when the motor 40 rotates, the rotation is transmitted to the bearing box 49 via the bearing 48 eccentric to the motor shaft 41, so that the bearing box 49 and the sanding pad 51 perform eccentric motion and rotational motion.

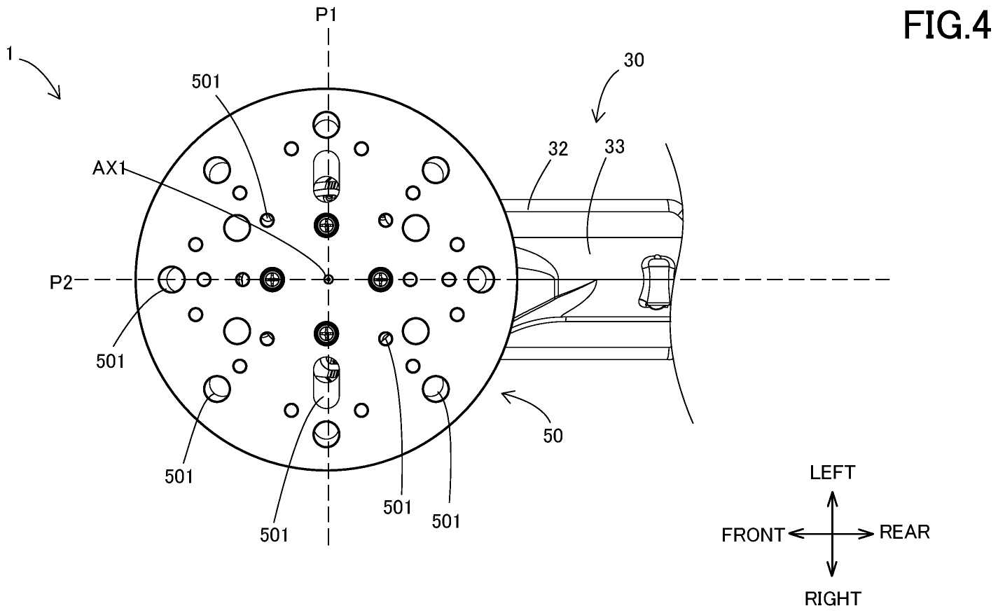

As shown in FIG. 4, dust suction holes 501 are formed through the sanding pad 51 in the up-down direction. The dust suction holes 501 communicate with the fan housing part 23 through the opening 235.

The internal configuration of the fan housing part 23 is now described. A scroll part 70 and a tongue part 80 are formed inside the fan housing part 23.

As shown in FIG. 12, the scroll part 70 is provided on a radially outer side of the dust collecting fan 62. The scroll part 70 forms a passage for leading air flow generated by the dust collecting fan 62 to the dust discharge part 33. This passage is also referred to as a scroll passage. The scroll part 70 is configured to have a cross-sectional passage area increasing along a rotating direction R1 of the fan 60. A scroll inlet S1 and a scroll outlet S2 of the scroll part 70 are defined by a left connection part 237 and a right connection part 238 of the connection part between the fan housing part 23 and the dust discharge part 33, respectively.

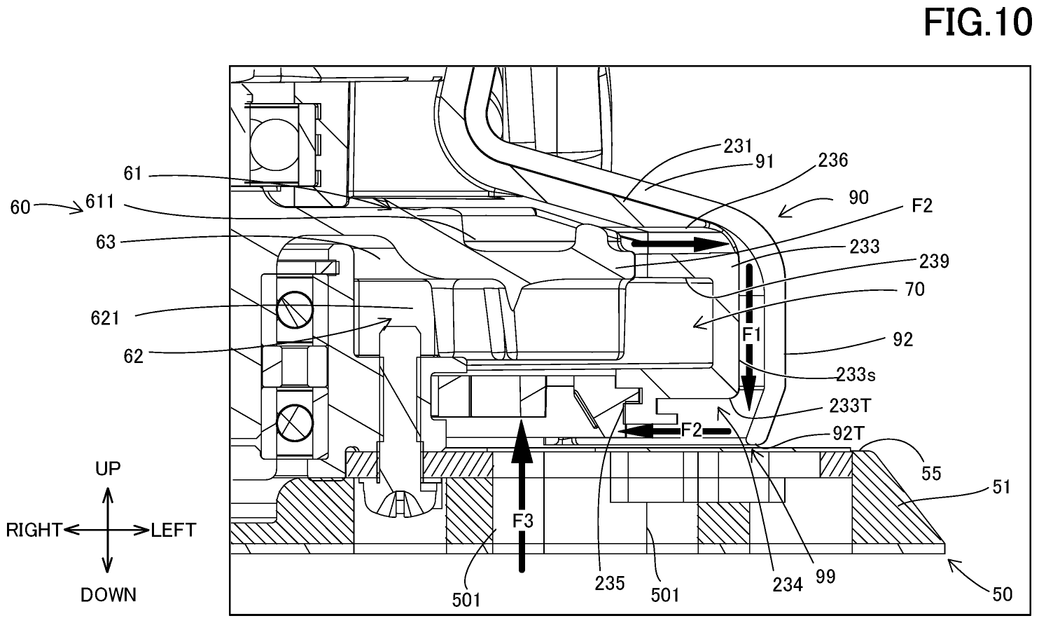

As shown in FIGS. 8 to 11, the scroll part 70 is provided below the air holes 236 in the fan housing part 23. As shown in FIG. 10, an inside upper wall 239 is formed below the air holes 236 and protrudes radially inward from the side wall 233. The inside upper wall 239 is formed on the radially outer side of the fan 60 and faces the lower wall 234 in the up-down direction. The scroll part 70 is mainly defined by a lower surface of the inside upper wall 239, an inner surface of the side wall 233 and an upper surface of the lower wall 234.

The tongue part 80 is formed on the scroll inlet S1 of the scroll part 70 and configured to lead air flow generated by the fan 60 (the dust collecting fan 62) to the dust discharge part 33. The tongue part 80 extends from the scroll inlet S1 side to the scroll outlet S2 side along the circumferential direction (specifically, a direction R2 opposite to the rotating direction R1). A tip 83 of the tongue part 80 (an end on the scroll outlet S2 side) is located on the right side of the plane P2.

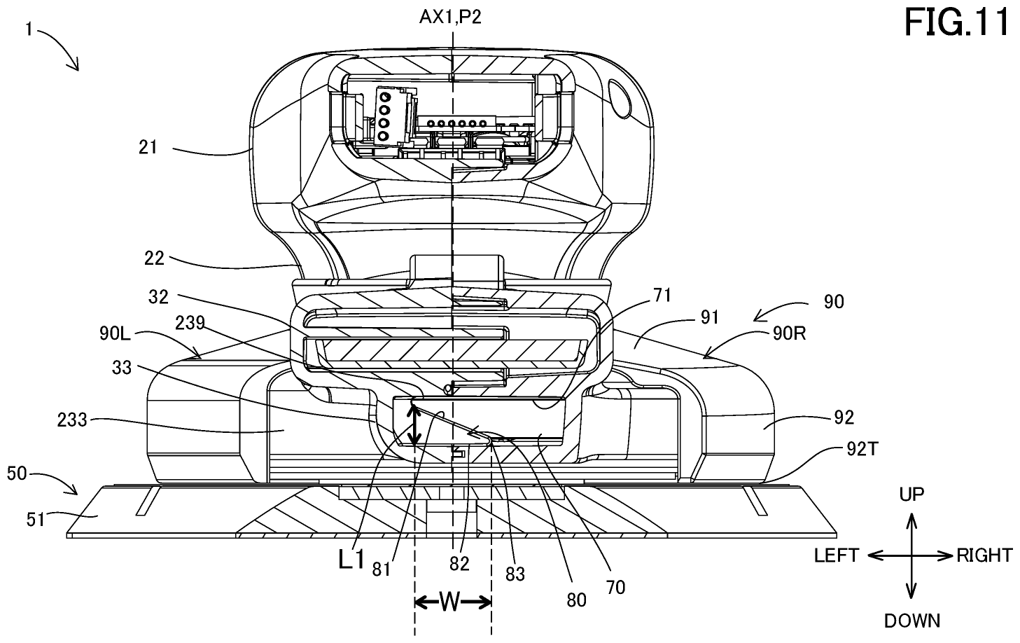

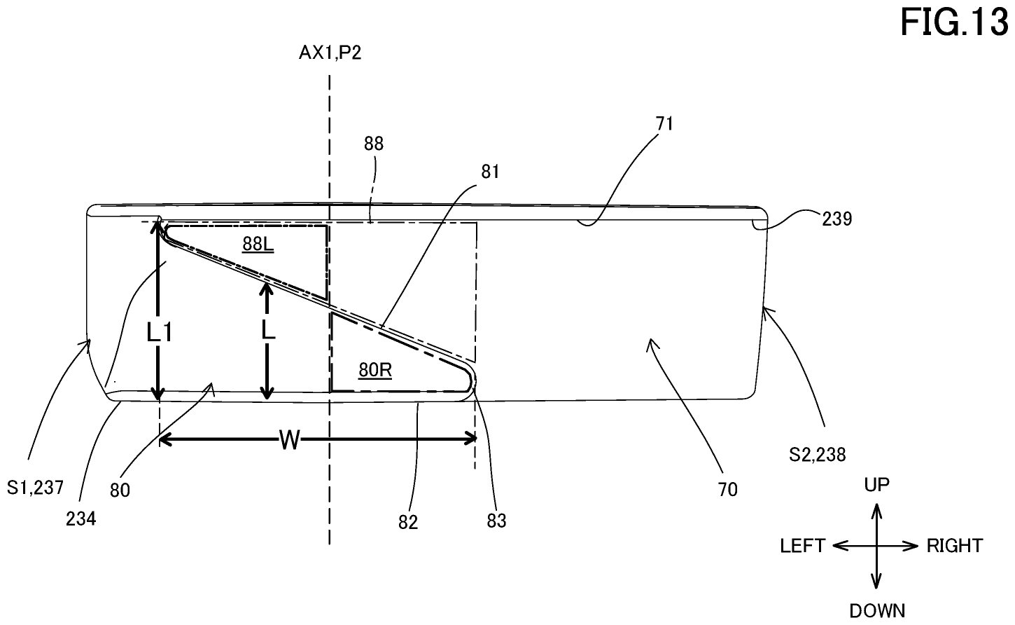

As shown in FIGS. 11 and 13, a length L of the tongue part 80 in the up-down direction broadly monotonously decreases from the scroll inlet S1 side to the scroll outlet S2 side. The broadly monotonous decrease can also be paraphrased as non-monotonous increase. In this embodiment, the length L of the tongue part 80 in the up-down direction continuously (gradually) decreases from the scroll inlet S1 side to the scroll outlet S2 side. In this embodiment, the tongue part 80 is formed by protruding a part of the side wall 233 on the scroll inlet S1 side to the scroll outlet S2 side and gradually decreasing the length L in the up-down direction.

A lower end 82 of the tongue part 80 is in contact with the lower wall 234, and an upper end 81 of the tongue part 80 extends to be gradually separated from the inner upper wall 239 along the direction R2 (from the left to the right as viewed in FIGS. 11 and 13). Thus, the upper end 81 of the tongue part 80 is linearly inclined downward.

As shown in FIG. 12, the tongue part 80 has a front wall part 85 facing the plane P1, and an inclined part 86 inclined rearward and downward from the front wall part 85. An upper end of the front wall part 85 is also the upper end 81 of the tongue part 80. The length of the inclined part 86 in the up-down direction gradually decreases toward the rear side. In this embodiment, the length of the tongue part 80 in the up-down direction gradually decreases from the scroll inlet S1 side to the scroll outlet S2 side. The rearward extending length of the inclined part 86 is the longest at one end on the scroll inlet S1 side and the shortest at the other end on the scroll outlet S2 side. The rearward extending length of the inclined part 86 gradually decreases from the scroll inlet S1 side to the scroll outlet S2 side. The inclined part 86 is a build-up part (clad part) connecting the front wall part 85 and the left part 10L of the dust discharge part 33. The inclined part 86 smoothly connects the front wall part 85 and the dust discharge part 33. Thus, when passing the tongue part 80 through the scroll part 70 and discharged to the dust discharge part 33, air and dust flow along the inclined part 86 after passing the front wall part 85, and then contact an inner wall (lower wall) of the dust discharge part 33.

In this embodiment, the tongue part 80 is integrally formed with the left part 10L of the housing 10. The tip 83 of the tongue part 80 is located on the right side of the plane P2 when the left part 10L and the right part 10R are assembled together. A spaced part 88 is defined by the upper end 81 of the tongue part 80 and the inner upper wall 239 being separated from each other in the up-down direction, and functions as part of an opening (the scroll opening 71) through which dust is discharged to the dust discharge part 33.

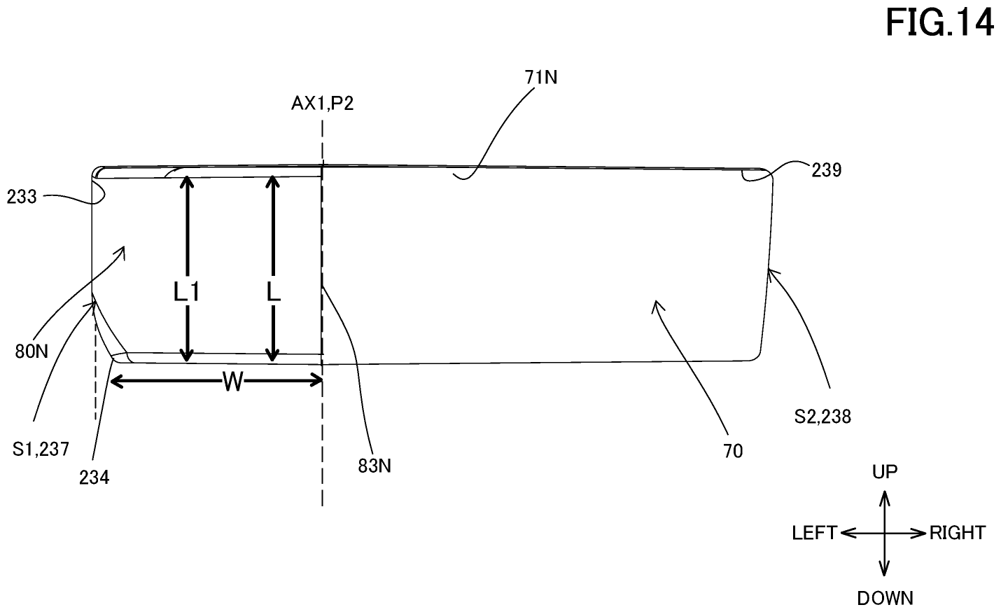

FIG. 13 shows an image formed by projecting a tongue part 80 and its periphery on a plane P1 from behind the tongue part 80. A left spaced part 88L of the spaced part 88 on the left side of the plane P2 has substantially the same shape as a right tongue part 80R on the right side of the plane P2 (more specifically, a right part of the front wall part 85 on the right side of the plane P2). In a comparative example shown in FIG. 14, a tongue part 80N is formed by the left part 10L of the side wall 233 of the fan housing part 23 being extended up to the plane P2 in contact with the inside upper wall 239 and the lower wall 234. A tip 83N of the tongue part 80N of the comparative example is located on the plane P2. Further, in the comparative example, a part between the inside upper wall 239 and the lower wall 234 on the right side of the tongue part 80N functions as a scroll opening 71N through which dust is discharged to the dust discharge part 33. The opening area of the scroll opening 71 having the tongue part 80 in this embodiment is substantially equal to the opening area of the scroll opening 71N of the comparative example. Further, the scroll opening 71 is extended further in the left-right direction (circumferential direction) than the scroll opening 71N of the comparative example.

As shown in FIGS. 1 to 3 and 9 to 11, the sander 10 further has a cover 90. The cover 90 is configured to cover the air holes 236 while being apart from the air holes 236. In this embodiment, the cover 90 is formed by two halves (a left part 90L and a right part 90R) fixedly connected together in the left-right direction. The left part 90L and the right part 90R of the cover 90 are screw clamped on a rear part of the intermediate part 22 (a front end upper part of the controller housing part 32) and on the front side of the side wall 233, and fixed to the fan housing part 23.

The cover 90 is shaped along the contour of the fan housing part 23. The cover 90 has a generally dome-like shape covering the fan housing part 23. An outer edge of the cover 90 is located radially inward of the outer edge of the pad 50. More specifically, the cover 90 covers the whole fan housing part 23 from the intermediate part 22 of the front housing part 20. The cover 90 has a first part 91 in contact with the fan housing part 23 and a second part 92 apart from the fan housing part 23. An inner surface of the first part 91 is in contact with the intermediate part 22 and an outer surface of the upper wall 231. The first part 91 is located above the air holes 236. The second part 92 is apart radially outward from the side wall 233 and extends substantially in the up-down direction. In this embodiment, the distance between the second part 92 and the side wall 233 is substantially constant in the radial direction. This distance may be a prescribed distance in the range of approximately 1.0 to 2.5 mm.

A lower end 92T of the second part 92 is located below the lower end 233T and the lower wall 234 of the fan housing part 23. Further, the lower end 92T of the second part 92 is apart upward from an upper surface 55 of the pad 50. Thus, the inside of the cover 90 communicates with the outside of the sander 1 through this space (clearance) between the lower end 92T and the upper surface 55 of the pad 50. The distance between the lower end 92T and the upper surface 55 in the up-down direction is shorter than the distance between the side wall 233 and the second part 92 in the radial direction.

In this embodiment, as described above, the fan housing part 23 except the connection part with the dust discharge part 33 is formed in a circular arc shape around the rotational axis AX1 in a cross section (for example, as shown in FIG. 12) orthogonal to the up-down direction. The cover 90 is shaped along the contour of the fan housing part 23. Thus, like the fan housing part 23, the cover 90 is formed in a circular arc shape around the rotational axis AX1 in a cross section (for example, as shown in FIG. 11) orthogonal to the up-down direction.

In the sander 1 having the above-described structure, when the switch 101 of the sander 1 is turned on by a user, the controller 65 controls power supply to the motor 40. When the motor rotates, the pad 50 performs eccentric motion and rotational motion (random orbital motion), thus allowing a user to perform sanding operation on a workpiece.

Further, the fan 60 is rotated by rotation of the motor 40. Air within the housing 10 is gathered to the fan 60 by the blades 611, 621 of the fan 60. At this time, air below the main plate 63 in the housing 10 is gathered to a lower part (the dust collecting fan 62) of the fan 60 by the blades 621. Thus, air flow from the dust suction holes 501 to the dust collecting fan 62 via the opening 235 is generated, and dust generated by sanding operation is led into the housing 10 together with air. This dust is discharged to the dust discharge part 33 through the scroll part 70 and the tongue part 80 that are provided on the radially outer side of the dust collecting fan 62. In this manner, dust is collected in the dust collecting pack 200 by air flow being generated toward the dust discharge part 33 via the dust suction holes 501 of the pad 50, the opening 235, the scroll part 70 and the tongue part 80.

Air above the main plate 63 in the housing 10 is gathered to an upper part (the motor cooling fan 61) of the fan 60 by the blades 611. Thus, air flow from the air inlets 301 to the motor cooling fan 61 is generated. Further, exhaust air (motor cooling air) from the motor cooling fan 61 is discharged out of the housing 10 from the air holes 236 formed on the radially outer side of the motor cooling fan 61. In this manner, the motor 40 is cooled by air flowing from the air inlets 301 to the air holes 236.

As described above, the fan housing part 23 is covered by the cover 90. As shown in FIG. 10, the first part 91 of the cover 90 extends in contact with the upper wall 231 of the fan housing part 23 above the air holes 236, and the second part 92 of the cover 90 is apart from the air holes 236 and extends in the up-down direction on the lower side of the first part 91. Therefore, air discharged from the air holes 236 flows downward through a first passage F1 defined by the second part 92 and an outer surface 233s of the side wall 233 of the fan housing part 23 (see FIG. 10).

Further, the motor cooling air flows through the first passage F1 and a second passage F2 that is defined by the lower wall 234 and the upper surface 55 of the pad 50 and is drawn to air flow flowing toward the fan housing part 23 from the dust suction holes 501. In FIG. 10, an example of passages (a third passage F3) of air flowing toward the fan housing part 23 from the dust suction holes 501 is shown. The motor cooling air discharged from the air holes 236 is led into the fan housing part 23 through the first passage F1, the second passage F2 and the third passage F3. The motor cooling air led into the fan housing part 23 is discharged to the dust discharge part 33 via the scroll part 70 and the tongue part 80.

With the above-described structure, in the sander 1 of this embodiment, the motor cooling air discharged from the air holes 236 is led downward, so that the possibility that dust scatters toward a user is reduced even if dust is mixed in the motor cooling air. Therefore, the working environment can be favorably maintained. Dust may be mixed in the motor cooling air, for example, if dust in the working environment flows into the housing 10 via the air inlets 301, or if dust flows into the fan housing part 23 via the dust suction holes 501 of the pad 50 and the opening 235 of the fan housing part 23 and moves upward through a clearance between the fan housing part 23 and the radially outer side of the fan 60.

In the sander 1 of this embodiment, the motor cooling air discharged from the air holes 236 is drawn to the air flow flowing (through the third passage F3) from the dust suction holes 501 toward the fan housing part 23, so that the possibility that dust scatters toward a user is further reduced. Further, the motor cooling air discharged from the air holes 236 joins the air flow generated by the dust collecting fan 62 and flowing from the dust suction holes 501 toward the fan housing part 23. Thus, dust mixed in the motor cooling air, if any, is collected in the dust collecting pack 200 via the scroll part 70, the tongue part 80 and the dust discharge part 33. Therefore, the working environment can be more favorably maintained.

Further, the flow rate (volume) of air for dust collection is increased by the confluence (joining) of the motor cooling air discharged from the air holes 236 and the air flow generated by the dust collection fan 62 and flowing from the dust suction holes 501 toward the fan housing part 23. Thus, the dust collecting efficiency is improved.

With the configuration in which the lower end 92T of the second part 92 of the cover 90 is apart upward from the upper surface 55 of the pad 50, the clearance between the lower end 92T of the cover 90 and the upper surface 55 of the pad 50 can be utilized as an auxiliary exhaust hole 99 (see FIG. 10) for discharging the motor cooling air. Therefore, even if the flow rate of air flowing from the dust suction holes 501 toward the dust discharge part 33 is reduced, the motor cooling air is discharged to the outside through the air holes 236, the first passage F1 and the auxiliary exhaust hole 99. Thus, the efficiency of cooling the motor 40 is maintained. The reduction of the flow rate of air flowing from the dust suction holes 501 toward the dust discharge part 33 is caused, for example, if dust collected in the dust collecting pack 200 exceeds a prescribed amount.

Further, with the configuration of the cover 90 shaped along the contour of the fan housing part 23, the width of the first passage F1 that is defined by the side wall 233 of the fan housing part 23 and the second part 92 of the cover 90 can be substantially constant in the radial direction. Thus, the flow rate (volume) of air (motor cooling air) flowing downward through the first passage F1 from the air holes 236 can be substantially constant in the radial direction, so that the possibility of the motor cooling air staying in a certain place within the fan housing part 23 is reduced. Therefore, the motor 40 is efficiently cooled.

Further, with the configuration of the cover 90 shaped along the contour of the fan housing part 23, the size increase of the sander 1 can be suppressed.

With the configuration in which the fan housing part 23 has the air holes 236 arranged in a circular arc, the possibility of the motor cooling air staying in a certain place within the fan housing part 23 is reduced. Therefore, the efficiency of cooling the motor 40 is improved. Further, a plurality of flows of air flowing from the air holes 236 to the opening 235 through the first and second passages F1, F2 are formed in the radial direction, so that the motor 40 is efficiently cooled.

Effects of the scroll part 70 and the tongue part 80 according to this embodiment are now described. In FIGS. 11 and 13, a length L1 of the longest part of the tongue part 80 having the length L in the up-down direction, and a length W of the tongue part 80 in the circumferential direction are shown. As described above, the length L of the tongue part 80 in the up-down direction gradually decreases from the scroll inlet S1 side to the scroll outlet S2 side. Therefore, air from the dust collecting fan 62 is led to the dust discharge part 33 while flowing in the direction R1 through the scroll part 70 and gradually coming into contact with the tongue part 80. This suppresses a sudden pressure change around the tongue part 80, and thus suppresses generation of noise caused by such a sudden pressure change around the tongue part 80. In this embodiment, the upper end 81 of the tongue part 80 is linearly inclined downward from the scroll inlet S1 side to the scroll outlet S2 side, so that the sudden pressure change is further suppressed. Thus, generation of noise is further suppressed. Further, by provision of the structure that suppresses the sudden pressure change around the tongue part 80, dust contained in the air from the dust collecting fan 62 is smoothly led to the dust discharge part 33 via the tongue part 80. Therefore, the dust collecting efficiency is improved.

Further, in this embodiment, the length W in the circumferential direction is longer than the length L1 in the up-down direction (see equation (1)). With this configuration, the length of contact (or the time of contact) between the tongue part 80 and the air led from the dust collecting fan 62 is increased, so that a sudden pressure change around the tongue part 80 is further suppressed. Thus, generation of noise is further suppressed and the dust collecting efficiency is further improved.

W>L1 (equation (1))

The length W in the circumferential direction is preferably not smaller than two times the length L1 in the up-down direction and not larger than three times the length L1 (see equation (2)). With this configuration of the tongue part 80, a sudden pressure change around the tongue part 80 is effectively suppressed. Thus, noise suppression and improvement of the dust collecting efficiency are effectively realized.

2L1≤W≤3L1 (equation (2))

Further, in this embodiment, the tongue part 80 is configured such that the length W in the circumferential direction is not smaller than the distance D1 (shown in FIG. 12) between the blades 621 of the dust collecting fan 62 (see equation (3)). Therefore, the two adjacent blades 621 arranged with the distance D1 pass the tongue part 80 at the same time by rotation of the dust collecting fan 62. With this configuration, a pressure change around the tongue part 80 is reduced.

D1≤W (equation (3))

The length W of the tongue part 80 in the circumferential direction is preferably not smaller than the distance D1 between the blades 621 and not larger than three times the distance D1 (see equation (4)). With this configuration of the tongue part 80, a pressure change around the tongue part 80 is reduced, and the area of the scroll opening 71 is sufficiently ensured. In this embodiment, the length W of the tongue part 80 in the circumferential direction is 1.2 times the distance D1.

D1≤W≤3D1 (equation (4))

In this embodiment, the housing 10 can be divided into the left part 10L and the right part 10R, and the tongue part 80 is integrally formed with one of the parts (the left part 10L) of the tongue part 80. The tip 83 of the tongue part 80 is located on the right side of the plane P2 when the left part 10L and the right part 10R are assembled together. Thus, the tongue part 80 can be easily formed while increasing the length W in the circumferential direction.

Further, the left spaced part 88L on the left side of the plane P2 in the spaced part 88 between the tongue part 80 and the inner upper wall 239 has substantially the same shape as the right tongue part 80R on the right side of the plane P2. Thus, the length W of the tongue part 80 in the circumferential direction can be increased, while the area (opening area) of the scroll opening 71 is sufficiently ensured. Therefore, according to this embodiment, the sander 1 can be easily manufactured which realizes noise suppression and improvement of the dust collecting efficiency.

Further, the tongue part 80 has the inclined part 86 inclined rearward and downward from the front wall part 85. Thus, when passing the tongue part 80 through the scroll part 70 and discharged to the dust discharge part 33, air and dust flow along the inclined part 86 after passing the front wall part 85, and then contact the inner wall (lower wall) of the dust discharge part 33. Therefore, compared with a structure in which the tongue part 80 does not have the inclined part 86, the possibility of dust staying right behind the front wall part 85 is reduced. Thus, the dust collecting efficiency is further improved.

Correspondences between the features of the above-described embodiment and the features of the present disclosure are as follows. However, the features of the above-described embodiment are merely exemplary and do not limit the features of the present disclosure or invention.

The sander 1 is an example of the “sander”.

The motor 40 is an example of the “motor”.

The motor shaft 41 is an example of the “output shaft”.

The pad 50 is an example of the “pad”.

The dust collecting fan 62 and the fan 60 are examples of the “dust collecting fan”.

The motor cooling fan 61 and the fan 60 are examples of the “motor cooling fan”.

The fan housing part 23 and the front housing part 20 are examples of the “housing”.

The cover 90 is an example of the “cover”.

The air hole 236 is an example of the “at least one air hole”.

The first part 91 and the second part 92 are examples of the “first part” and the “second part”, respectively.

The dust suction hole 501 is an example of the “at least one dust suction hole”.

The upper surface 55 is an example of the “upper surface of the pad”.

The lower wall 234 is an example of the “lower wall”.

The opening 235 is an example of the “lower opening”.

The lower end 233T is an example of the “lower end of the second part”.

The outer surface 233s is an example of the “outer surface of the housing”.

The first passage F1 and the second passage F2 are examples of the “first passage” and the “second passage”, respectively.

The dust discharge part 33 is an example of the “dust discharge part”.

### Other Embodiments

The sander according to the present disclosure is not limited to the sander 1 of the above-described embodiment. For example, the following non-limiting modifications may be made. At least one of these modifications can be adopted in combination with at least one of the features of the sander 1 and the claimed invention.

The number and arrangement of the air holes 236 for discharging motor cooling air are not limited to those of the above-described embodiment. The number and arrangement of the air inlets 301 for the motor cooling air, the number and arrangement of the dust suction holes 501 of the pad 50, and the shape of the opening 235 formed in the lower part of the housing 10 may be appropriately changed according to the shape of a sander to which a technique of the present disclosure is applied.

The dust collecting fan 62 and the motor cooling fan 61 may be separately formed from each other. With this configuration, like in the above-described embodiment, the working environment can also be favorably maintained. Further, noise caused by rotation of the dust collecting fan 62 is reduced and the dust collecting efficiency is improved.

The cover 90 may be integrally formed with the housing 10. This can eliminate the trouble of mounting the cover 90 onto the housing 10. The shape of the cover 90 is not limited to that of the above-described embodiment insofar as the cover 90 is arranged outside the housing 10 so as to allow flow of air between the inside and the outside of the housing 10 at least via the air holes 236. For example, the cover 90 may be configured to cover the air holes 236 by extending the roof-shaped first part 91 further radially outward. In this case, the cover 90 does not need to have the second part 92. With this configuration, the possibility that dust scatters to the working environment is also reduced. Further, the possibility that dust scatters toward a user is also reduced since the cover 90 is arranged above the air holes 236.

The pad 50 only needs to be operably connected to the motor shaft 41. A shaft for driving the pad 50 and a shaft of the fan 60 may be formed separately from the motor shaft 41. The pad 50 and a shaft of the fan 60 may be arranged to cross the rotational axis AX1 of the motor shaft 41.

The dust discharge part 33 only needs to be connected to the fan housing part 23 and to extend orthogonally to the plane P1. For example, the dust discharge part 33 may be formed along the outer edge of the fan housing part 23 on the right side of the plane P2. With this configuration, noise caused by a sudden pressure change around the tongue part 80 is also suppressed. Further, dust is smoothly discharged from the fan housing part 23 to the dust discharge part 33.

The length L of the tongue part 80 in the up-down direction only needs to broadly monotonously decrease from the scroll inlet S1 side to the scroll outlet S2 side. For example, part of the tongue part 80 may have the length L constant in the up-down direction. With this configuration, noise caused by a sudden pressure change around the tongue part 80 is also suppressed. Further, dust is smoothly discharged from the fan housing part 23 to the dust discharge part 33.

In the above-described embodiment, a random orbital sander is described as a representative example, but the features of the present disclosure may be applied to other sanders having the pad 50 and the fan 60 that are driven by the motor 40. An example of the sander is an orbital sander having a pad configured to perform eccentric motion. The structures and arrangement of the motor 40 and the fan 60, and the shape of the cover 90 may be appropriately changed according to the sander to which the features of this disclosure is applied. For example, the motor 40 may be a DC motor (such as a brushless DC motor). In this case, for example, the sander 1 may be provided with a battery mounting part to which a rechargeable battery (battery pack) can be removably mounted.

Further, in view of the nature of the present disclosure and the above-described embodiment, the following aspects can be provided. At least one of the following aspects can be adopted in combination with at least one of the features of the above-described embodiment, its modifications and the claimed invention.
(Aspect 1) The dust discharge part has a mounting part configured such that a dust collecting part for collecting dust can be removably attached thereto.
(Aspect 2) The housing has a grip part provided on the upper side in the up-down direction and configured to be held by a user.
(Aspect 3) An outer edge of the cover is located inward of an outer edge of the pad.
(Aspect 4) The sander further comprises a scroll part that is formed on a radially outer side of the dust collecting fan along a circumferential direction and configured such that air flow generated by the dust collecting fan is led to the discharge part, and
   the at least one air hole is formed above (on the upper side of) the scroll part in the up-down direction.
(Aspect 5) The scroll part includes the lower wall of the housing, a side wall and an inside upper wall protruding radially inward from the side wall, and
   the air hole is formed above the inside upper wall.
(Aspect 6) The housing has an air inlet that is provided for communication between the inside and outside of the housing such that air flowing into the housing from the air inlet cools the motor.

### DESCRIPTION OF THE REFERENCE NUMERALS

1: sander, 10: housing, 10L: left part, 10R: right part, 20: front housing part, 21: motor housing part, 22: intermediate part, 23: fan housing part, 231: upper wall, 232: connection part, 233: side wall, 233T: lower end, 233s: outer surface, 234: lower wall, 235: opening, 236: air hole, 237, 238: connection part, 239: inside upper wall, 30: rear housing part, 301: air inlet, 31: grip part, 32: controller housing part, 33: dust discharge part, 331: mounting part, 40: motor, 41: motor shaft, 42: motor body, 44: bearing, 45: bearing, 46: bolt, 48: bearing, 49: bearing box, 50: pad, 501: dust suction hole, 51: sanding pad, 55: upper surface, 56: bolt, 60: fan, 61: motor cooling fan, 611: blade, 62: dust collecting fan, 621: blade, 63: main plate, 65: controller, 70: scroll part, 71: scroll opening, 80: tongue part, 80L: left tongue part, 80R: right tongue part, 81: upper end, 82: lower end, 83: tip, 85: front wall part, 86: inclined part, 88: spaced part, 88L: (left) spaced part, 71N: scroll opening of the comparative example, 80N: tongue part of the comparative example, 83N: tip of the comparative example, 90: cover, 90L: left part, 90R: right part, 91: first part, 92: second part, 92T: lower end, 99: auxiliary exhaust hole, 101: switch, 200: dust collecting pack, AX1: rotational axis, D1: distance, F1: first passage, F2: second passage, F3: third passage, P1: plane, P2: plane, S1: scroll inlet, S2: scroll outlet

1. A sander, comprising:
a motor;
an output shaft that has an axis extending in an up-down direction and is configured to be rotated by the motor;
a pad that is operably connected to the output shaft and configured to be driven by the motor;
a dust collecting fan that is fixed to the output shaft so as to surround the output shaft in a circumferential direction;
a motor cooling fan that is arranged on an upper side relative to the dust collecting fan, where, in the up-down direction, a side on which the pad is arranged relative to the dust collecting fan is defined as a lower side of the sander and a side opposite to the lower side is defined as the upper side of the sander, the motor cooling fan being configured to be rotated by the motor;
a housing that is arranged on the upper side of the pad and configured to house the motor, the motor cooling fan, the dust collecting fan and at least part of the output shaft, the housing having at least one air hole formed through the housing in a direction crossing the axis; and
a cover that is arranged outside the housing and configured to cover the air hole while being apart from the air hole.

2. The sander as defined in claim 1, wherein:
the cover has a first part and a second part,
the first part is connected to the housing on the upper side relative to the air hole, and
the second part is apart from the housing and extends in the up-down direction on the lower side of the first part.

3. The sander as defined in claim 2, wherein:
the pad has at least one dust suction hole formed through the pad in the up-down direction,
the housing has a lower wall facing an upper surface of the pad, the lower wall having a lower opening for communication between an inside of the housing and the dust suction hole,
a lower end of the second part is located between the lower wall of the housing and the upper surface of the pad in the up-down direction,
the sander further comprises a first passage defined by the second part and an outer surface of the housing, and a second passage defined by the lower wall of the housing and the upper surface of the pad, and
the first passage communicates with the dust suction hole via the second passage.

4. The sander as defined in claim 3, wherein the lower end of the second part is apart from the upper surface of the pad in the up-down direction.

5. The sander as defined in claim 1, wherein the air hole is arranged substantially at the same position as the motor cooling fan in the up-down direction and on a radially outer side of the motor cooling fan.

6. The sander as defined in claim 1, wherein:
the at least one air hole comprises a plurality of air holes, and
the cover is shaped along a contour of the housing.

7. The sander as defined in claim 6, further comprising:
a dust discharge part that is connected to the housing and extends in a direction crossing the up-down direction,
wherein:
the housing except a connection part with the dust discharge part is formed in a circular arc shape around the axis in a cross section orthogonal to the up-down direction,
the air holes are arranged in a circular arc in the housing, and
the cover has a dome-like shape covering the housing.

8. The sander as defined in claim 1, wherein the dust collecting fan and the motor cooling fan are integrally formed with each other.

9. The sander as defined in claim 1, wherein the cover is formed as a separate member from the housing.

10. The sander as defined in claim 3, comprising:
a grip part that extends in a longitudinal direction of the sander and is configured such that the inside of the housing communicates with an inside of the grip part,
wherein:
the grip part has at least one air inlet for communication between the inside and outside of the grip part, and
the sander is configured such that air flows into the housing through the grip part from the air inlet by rotation of the motor and is discharged from the air hole, and flows through the first passage and then the second passage.

11. The sander as defined in claim 10, comprising:
a third passage that is defined by the dust suction hole and the lower opening, wherein:
the sander is configured such that the air flowing through the second passage is drawn to air flowing into the third passage from the dust suction hole by rotation of the motor.

12. The sander as defined in claim 11, further comprising:
a dust discharge part that is connected to the housing and extends in a direction crossing the up-down direction,
wherein:
the housing has a scroll part that is formed on a radially outer side of the dust collecting fan and communicates with the dust discharge part, and
the third passage directly or indirectly communicates with a scroll passage defined by the scroll part.
